(19) United States
(12) Patent Application Publication
(10) Pub. No.: US 2018/0371313 A1
(43) Pub. Date: Dec. 27, 2018

(54) COMPOSITE PARTICLES COMPRISING QUANTUM DOTS AND METHODS OF MAKING THE SAME

(71) Applicant: 3M INNOVATIVE PROPERTIES COMPANY, St. Paul, MN (US)

(72) Inventors: Mahmut AKSIT, Woodbury, MN (US); Kenton D. BUDD, Woodbury, MN (US); Neeraj SHARMA, Woodbury, MN (US)

(21) Appl. No.: 16/066,845

(22) PCT Filed: Dec. 28, 2016
(86) PCT No.: PCT/US2016/068782

§ 371 Date: Jun. 28, 2018

Related U.S. Application Data
(60) Provisional application No. 62/273,884, filed on Dec. 31, 2015.

(51) Int. Cl. C09K 11/02; C09K 11/88

(52) U.S. Cl. CPC C09K 11/025; B82Y 20/00; C09K 11/883

(57) ABSTRACT

Composite particles comprising quantum dot light emitters, a nonvolatile liquid ligand system, and hydrolyzed organometallic metal oxide precursor, wherein the quantum dot light emitters and the nonvolatile liquid ligand system are collectively present in the composite particles in an amount of at least 30 weight percent. Composite particles described herein are useful, for example, in films (e.g., remote phosphor diffuser films). Remote phosphor diffuser films are useful, for example, in LCD displays.

### CROSS REFERENCE TO RELATED APPLICATION

This application claims the benefit of U.S. Provisional Patent Application No. 62/273,884, filed Dec. 31, 2015, the disclosure of which is incorporated by reference herein in its entirety.

### BACKGROUND

Quantum dots (light emitting semiconductor nanoparticles) such as CdSe or InP are useful as phosphor materials. Uses of quantum dots include backlights for liquid crystal displays (LCD) displays. Light from short wavelength light emitting diodes (LED) is converted to desired visible wavelengths by the quantum dots. For example, a backlight can comprise blue emitting LEDs, and red and green emitting quantum dots that adsorb part of the blue light. Quantum dots can be used to create narrow emission peaks, resulting in displays with high color gamut.

### SUMMARY

In one aspect, the present disclosure describes a composite particle comprising:

quantum dot light emitters;

a nonvolatile liquid ligand system; and

a hydrolyzed organometallic metal oxide precursor (e.g., metal alkoxides, metal alkyls, metal chlorides, silanes, and mixed ligand compounds),

wherein the quantum dot light emitters and the nonvolatile liquid ligand system are collectively present in the composite particle in an amount of at least 30 (in some embodiments, at least 35, 40, 45, 50, 55, 60, 65, 70; in some embodiments, in a range from 30 to 70, or even 40 to 60) weight percent.

In another one aspect, the present disclosure describes a method of making composite particles described herein, the method comprising:

combining a mixture of quantum dot light emitters in a liquid ligand system with an organometallic metal oxide precursor;

reacting the organometallic metal oxide precursor with water; and

at least partially drying the reacted mixture to provide the composite particles.

In another aspect, the present disclosure describes a method of making composite particles, the method comprising:

combining a mixture of quantum dot light emitters in a liquid ligand system with an organometallic metal oxide precursor;

reacting the combination with a mixture of a polyacid and water; and

at least partially drying the reacted mixture to provide the composite particles, wherein the quantum dot light emitters and all material from the liquid ligand system remaining after said reacting and said at least partially drying collectively comprises at least 30 (in some embodiments, at least 35, 40, 45, 50, 55, 60, 65, 70; in some embodiments, in a range from 30 to 70, or even 40 to 60) percent by weight of the composite particles.

Composite particles described herein are useful, for example, in films (e.g., remote phosphor diffuser films). Remote phosphor diffuser films are useful, for example, in LCD displays. In some embodiments, the films have an External Quantum Efficiency of at least 70% (in some embodiments, at least 80%, or even at least 85%).

### DETAILED DESCRIPTION

Composite articles described herein can be made, for example, by a method comprising:

combining a mixture of quantum dot light emitters in a liquid ligand system with an organometallic metal oxide precursor;

reacting the organometallic metal oxide precursor with water; and

at least partially drying the reacted mixture to provide the composite particles.

Composite articles, including composite particles described herein, can be made, for example, by a method comprising:

combining a mixture of quantum dot light emitters in a liquid ligand system with an organometallic metal oxide precursor;

reacting the combination with a mixture of a polyacid and water; and

at least partially drying the reacted mixture to provide the composite particles, wherein the quantum dot light emitters and all material from the liquid ligand system remaining after said reacting and said at least partially drying collectively comprises at least 30 (in some embodiments, at least 35, 40, 45, 50, 55, 60, 65, 70; in some embodiments, in a range from 30 to 70, or even 40 to 60) percent by weight of the composite particles.

Quantum dot light emitters are known in the art. In general, they are semiconductor nanoparticles that are sufficiently small to exhibit size dependent light absorption and emission properties due to quantum confinement effects. The peak absorption and emission wavelengths typically decrease with decreasing particle size.

Quantum dots are commercially available, for example, from Nanosys, Inc., Milpitas, Calif. The quantum dots are typically provided with the quantum dots in a liquid (e.g., a solvent such as toluene, or a liquid ligand system). In some embodiments, the quantum dots comprise at least one of ZnS, ZnSe, CdS, CdSe, PbS, InP, InAs, GaAs, GaP, Si, or Ge. In some embodiments, the quantum dots comprise CdSe or InP nanoparticles. Typically, the quantum dots comprise so-called core-shell structures, with a core of the desired semiconductor nanoparticle (e.g., CdSe cores or InP cores), and at least one shell of additional material that provides desired stability and surface chemical or electronic properties. Exemplary materials include a CdSe core and a CdS intermediate layer. In one embodiment, the quantum dots have a CdSe core, a ZnSe middle layer, and a ZnS shell. In another embodiment, the structure is an InP core-ZnSe intermediate-ZnS shell.

Quantum dots (light emitting semiconductor nanoparticles) typically have selected molecules, oligomers, or polymers bound to their surfaces, resulting in a desirable local ligand environment for atoms at the surfaces of the quantum dots. Generally, certain ligands are present during the growth process used to synthesize the quantum dots. Often, these ligands are replaced or exchanged at a later time to provide a new ligand environment selected to optimize properties. Ligands perform several functions. They help prevent quantum dots from clustering and quenching, they can improve the chemical stability of the quantum dot surface, and they can improve the emission efficiency of the quantum dots. Ligand systems can include several forms. In general, they can include molecules or functional groups directly bound to the quantum dots, and optionally, to additional material. The additional material can be liquid or solid, and can be the same composition or a different composition compared to the bound material (e.g., a ligand system could comprise a bound species and a solvent).

A nonvolatile liquid ligand system is a liquid material comprising a mixture of bound chemical groups (groups chemically bound to the surfaces of quantum dot light emitting particles) and free chemical groups (groups not chemically bound to the surfaces of quantum dot light emitting particles) for which the volatility of the liquid is sufficiently low so that less than 20% (in some embodiments, less than 10%, or even less than 5%) of the liquid volatilizes during the Volatilization Test described below. Typically at least 10% (in some embodiments, at least 20%, at least 30%, or even at least 50%) by weight of the liquid is not chemically bound to the quantum dot light emitting particles. Materials containing nonvolatile liquid ligand systems can typically be dried or processed (e.g., oven drying at 100° C., or vacuum drying) with small or negligible loss of material.

A standard volatilization test (referred to herein as “Volatilization Test”) comprises placing 5 grams of a mixture of quantum dots plus a liquid ligand system in a container with an open surface area of 2 cm². The mixture is heated to 100° C. and held at 100° C. for 5 hours, then cooled to 25° C. The weight loss of the mixture is then determined, and is less than 20% for a nonvolatile liquid ligand system.

If a volatile liquid such as a solvent is present, it is considered to be part of the liquid ligand system. Systems having significant amounts of volatile solvents can lose greater than 20 wt. % of the liquid during a standard volatilization test (i.e., systems that are not a nonvolatile liquid ligand system) or during drying of a material. A material containing a volatile solvent can be converted to a material having a nonvolatile liquid ligand system by drying, so long as a nonvolatile liquid material remains following drying.

In some embodiments, the liquid ligand system comprises silicone oil. An example of such a ligand system for CdSe-based quantum dots is a liquid aminosilicone type oil with both bound material and additional material of similar composition.

Other exemplary ligands include at least one of organic, organometallic, or polymeric ligands. Suitable ligands include polymers, glassy polymers, silicones, carboxylic acid, dicarboxylic acid, poly-carboxylic acid, acrylic acid, phosphonic acid, phosphonate, phosphine, phosphine oxide, sulfur, amines, amines combined with epoxides to form an epoxy, monomers of any of the polymeric ligands mentioned herein, or any suitable combination of these materials. The quantum dot ligands can include amine-containing organic polymers such as aminosilicone (AMS) (available, for example, under the trade designations “AMS-242” and “AMS-233” from Gelest, Inc., Morrisville, Pa., and “GP-998” from Genesee Polymers Corp., Burton, Mich.); and poly-ether amines (available, for example, under the trade designation “JEFFAMINE” from Huntsman Corporation, The Woodlands, Tex.).

Suitable ligands include ligands having one or more quantum dot-binding moieties (e.g., an amine moiety or a dicarboxylic acid moiety). Exemplary amine ligands include aliphatic amines (e.g., decylamine or octylamine), and polymeric amines.

Nonvolatile liquid ligands comprise sufficiently high molecular weight liquid versions of the chemistries described above. Typically, liquid ligands comprising monomers or polymers having chemical backbones of at least about eight units long, or chemical species with carbon chains of about eight units or more, and having little or no additional shorter chain volatile solvents provide nonvolatile ligand systems. Examples of nonvolatile liquid ligand systems include any of the aminosilicone materials listed above, C₈ compounds (e.g., isooctyl acrylate and isooctyl methacrylate, trioctyl phosphate and dioctyl phosphonate), fluorocarbons and fluoropolymers (e.g., hexafluoropropylene oxide), and poly-ether amine (available, for example, under the trade designation “JEFFAMINE” from Huntsman Corporation).

Some embodiments of the composite particles described herein can be advantageous in that they can maintain a desirable ligand environment, including an environment comprising a liquid ligand system. Surprisingly, even when a particle is greater than 50 volume % liquid, confinement within a nanoporous matrix can enable dry powder characteristics, such as the ability to be ground.

A grindable powder is a powder that can be subdivided by mechanical force or abrasion resulting in a significant fraction of particles (greater than 50 wt. % of the powder) below a target size (below 100 micrometers in diameter) and capable of passing through a sieve with openings equal to the target diameter (100 micrometers).

A hydrolyzed organometallic metal oxide precursor is the product of a reaction between a hydrolysable organometallic precursor and water. A hydrolyzable organometallic metal oxide precursor is a compound that can be reacted with water to form a reaction product comprising primarily metal oxide. Examples of hydrolysable organometallic metal oxide precursors include metal alkoxides (e.g., zirconium n-propoxide, tetraethyl orthosilicate, and titanium isopropoxide), metal chlorides (e.g., titanium tetrachloride and silicon tetrachloride), and metal alkyls (e.g., trimethyl aluminum and diethyl zinc). Precursors can be mixed ligand compounds (i.e., those having multiple types of organometallic groups (e.g., titanium diisopropoxide dichloride)).

The hydrolyzed product is typically an amorphous metal oxide compound containing residual amounts of hydroxyl groups, trapped solvent and reaction products (e.g., alcohols), and unreacted precursor components (e.g., alkoxy, chloride, or alkyl groups). Exemplary metal oxides include oxides of metal elements include Al, Si, Ti, Zr, Mg, and Zn. Exemplary metal oxides include forms such as hydroxides, and hydrous oxides, as well as forms with mixed residual anions (e.g., oxide plus halides, hydroxyls, small amounts of alkyls, alkoxy groups, or carboxylates). The metal oxide materials can be amorphous, crystalline, or mixed, single or multiphase, and can contain one or more cations and one or more anions. The product can be heated or exposed to vacuum to further dry the product (i.e., to further remove residual water, solvents, reaction products, or unreacted components).

In some embodiments, the quantum dot light emitters and the nonvolatile liquid ligand system are collectively present in the composite particle in an amount of at least 30 (in some embodiments, at least 35, 40, 45, 50, 55, 60, 65, or even 70) weight percent. In some embodiments, the quantum dot light emitters and the nonvolatile liquid ligand system are collectively present in the composite particle in an amount in a range from 30 to 70 (in some embodiments 40 to 60) weight percent.

In some embodiments, the quantum dot light emitters are present in a range from 1 to 30 (in some embodiments, 2 to 20, 5 to 10, or even 5 to 20) percent by weight of the quantum dot light emitters and the nonvolatile liquid ligand system.

In some embodiments, the hydrolyzed organometallic metal oxide precursor is present in the composite particle in an amount in a range from 70 to 30 (in some embodiments 60 to 40) weight percent.

An exemplary polyacid for the method involving reacting a mixture of water and the polyacid with a combination of quantum dot light emitters in a liquid ligand system with an organometallic metal oxide precursor is polyacrylic acid. In some embodiments, the quantum dot light emitters are present in a range from 0.5 to 20 (in some embodiments, in a range from 1 to 10, 2 to 5, or even 2 to 10) percent by weight of the composite particles. In some embodiments, the amount of the organometallic metal oxide precursor reacted is in a range from 70 to 30 (in some embodiments, in a range from 60 to 40) percent by weight of the composite particles.

Composite particles described herein are useful, for example, in films (e.g., remote phosphor diffuser films). Remote phosphor diffuser films are useful, for example, in LCD displays. In some embodiments, the films have an External Quantum Efficiency of at least 70% (in some embodiments, at least 75%, 80%, or even at least 85%).

Composite particles described herein can be made by selected sequences of mixing components, reacting, drying, and grinding. For example, quantum dots having a nonvolatile liquid ligand system can be mixed with a metal alkoxide (e.g., a liquid alkoxide such as tetraethyl orthosilicate, zirconium n-propoxide, or titanium isopropoxide), or a metal alkoxide plus a solvent (e.g., an alcohol such as methanol, ethanol, or isopropanol). The mixture can be combined with a second mixture (e.g., an alcohol plus water) to form a material comprising quantum dots, ligand materials, and hydrolyzed metal alkoxide, along with solvents, other reaction products such as alcohols, and in some cases, residual water. The product can be dried by methods such as heating (e.g., at 50° C. to 200° C.) or evacuation to at least partially remove solvents, reaction products, and residual water. In some embodiments, a mixture containing quantum dots, ligands, and a hydrolysable metal oxide precursor is combined with a mixture containing both water and a polyacid.

Typically, the dried product is converted to a fine powder (e.g., a powder wherein the average particle diameter is less than 100 micrometers (in some embodiments, 75 micrometers, 50 micrometers, or even 25 micrometers) by grinding or milling. Suitable grinding and milling methods are known in the art and include the use of ball mills, shaker mills, and mortar and pestle. The ground product can be further processed by passing it through a sieve of a desired size.

Composite particles described herein can be incorporated into a matrix to provide articles used for display applications such as films, LED caps, LED coatings, LED lenses, and light guides.

In some embodiments, films comprising composite particles described herein are made. In some embodiments, a film further comprises a high barrier substrate film. Films can be made, for example, by coating a material onto a substrate and curing (polymerizing or crosslinking) the material, or by extrusion.

Composite particles described herein also can be incorporated into a matrix to provide articles used for non-display applications. For example, quantum dot phosphors can be used in security applications by providing fluorescence at selected or tailored wavelengths. In such uses, the matrix could be a label or a coating on a label, or other articles such as a card or tag.

Exemplary matrix materials include polymers. Suitable polymers include epoxies, acrylates, methacrylates, and thermoplastics (e.g., polyethylene, polypropylene, and polyesters). In some embodiments, a polymer matrix is a thiol-ene matrix (e.g., a thiol-alkene polymer). In some embodiments, the thiol-alkene matrix is the cured reaction product of a polythiol and a polyalkenyl compound (polyalkene), at least one of which has a functionality of >2.

In some embodiments, composite particles described herein exhibit high luminescent efficiency. For examples, films containing the composite particles may exhibit external quantum efficiencies (EQE values) of greater than 70% (in some embodiments, 75%, 80%, 85%, or even 90%). In some embodiments, composite particles described herein may exhibit as high or higher efficiency than the component quantum dot plus liquid ligand system used in the synthesis of the particles.

### Exemplary Embodiments

1A. A composite particle comprising:

quantum dot light emitters;

a nonvolatile liquid ligand system; and

hydrolyzed organometallic metal oxide precursor (e.g., metal alkoxides, metal alkyls, metal chlorides, silanes, and mixed ligand compounds),

wherein the quantum dot light emitters and the nonvolatile liquid ligand system are collectively present in the composite particle in an amount of at least 30 (in some embodiments, at least 35, 40, 45, 50, 55, 60, 65, 70; in some embodiments, in a range from 30 to 70, or even 40 to 60) weight percent.
2A. The composite particle of Exemplary Embodiment 1A, wherein the quantum dot light emitters are present in a range from 1 to 30 (in some embodiments, in a range from 2 to 20, 5 to 10, or even 5 to 20) percent by weight of the quantum dot light emitters and the nonvolatile liquid ligand system.
3A. The composite particle of any preceding A Exemplary Embodiment, wherein the hydrolyzed organometallic metal oxide precursor is present in the composite particle in a range from 70 to 30 (in some embodiments, in a range from 60 to 40) weight percent.
4A. The composite particle of any preceding A Exemplary Embodiment, wherein the quantum dot light emitters comprise at least one of CdSe cores or InP cores.
5A. The composite particle of any preceding A Exemplary Embodiment, wherein the liquid ligand system comprises silicone oil.
6A. The composite particle of any preceding A Exemplary Embodiment, wherein the hydrolyzed organometallic metal oxide precursor comprises hydrolyzed metal alkoxide.
7A. The composite particle of Exemplary Embodiment 6A, wherein the hydrolyzed metal alkoxide is at least one of hydrolyzed zirconium n-propoxide (ZNP), hydrolyzed tetraethyl orthosilicate (TEOS), or hydrolyzed titanium isopropoxide (TIP).
1B. A plurality of the composite particles of any preceding A Exemplary Embodiment.
2B. The plurality of the composite particles of Exemplary Embodiment 1B that is a grindable powder.
1C. A film comprising the composite particles of any preceding B Exemplary Embodiment.
2C. The film of Exemplary Embodiment 1C having an External Quantum Efficiency of at least 70% (in some embodiments, at least 75%, 80%, or even at least 85%).
3C. The film of any preceding C Exemplary Embodiment, wherein the film further comprises a high barrier substrate film.
1D. An article comprising the composite particles of any preceding B Exemplary Embodiment in a matrix comprising thiolene.
1E. A method of making composite particles of either Exemplary Embodiment 1B or 2B, the method comprising:

combining a mixture of quantum dot light emitters in a liquid ligand system with an organometallic metal oxide precursor;

reacting the organometallic metal oxide precursor with water; and

at least partially drying the reacted mixture to provide the composite particles.

1F. A method of making composite particles, the method comprising:

combining a mixture of quantum dot light emitters in a liquid ligand system with an organometallic metal oxide precursor;

reacting the combination with a mixture of a polyacid and water; and

at least partially drying the reacted mixture to provide the composite particles,

wherein the quantum dot light emitters and all material from the liquid ligand system remaining after said reacting and said at least partially drying collectively comprises at least 30 (in some embodiments, at least 35, 40, 45, 50, 55, 60, 65, 70; in some embodiments, in a range from 30 to 70, or even 40 to 60) percent by weight of the composite particles.
2F. The method of Exemplary Embodiment 1F, wherein the polyacid is polyacrylic acid.
3F. The method of either Exemplary Embodiment 1F or 2F, wherein the quantum dot light emitters are present in a range from 0.5 to 20 (in some embodiments, in a range from 1 to 10, 2 to 5, or even 2 to 10) percent by weight of the composite particles.
4F. The method of any preceding F Exemplary Embodiment, wherein the amount of the organometallic metal oxide precursor reacted is in a range from 70 to 30 (in some embodiments, in a range from 60 to 40) percent by weight of the composite particles.
5F. The method of any preceding F Exemplary Embodiment, wherein the quantum dot light emitters comprise at least one of CdSe cores or InP cores.
6F. The method of any preceding F Exemplary Embodiment, wherein the liquid ligand system comprises silicone oil.
7F. The method of any preceding F Exemplary Embodiment, wherein the organometallic metal oxide precursor is a metal alkoxide.
8F. The method of Exemplary Embodiment 7F, wherein the metal alkoxide is at least one of zirconium n-propoxide (ZNP), tetraethyl orthosilicate (TEOS), or titanium isopropoxide (TIP).

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

Materials used for preparing the Examples are described in Table 1, below.

TABLE 1

| | | Molecular | | |
|---|---|---|---|---|
| Material Name | Abbreviation | Formula | Source | Source Information |
| Water | N/A | H₂O | — | — |
| Isopropyl alcohol | IPA | C₃H₇OH | Sigma Aldrich, | Cat. No: BDH1133-4LP, |
| | | | St. Louis, MO | Assay: 99.5% |
| Tetraethoxysilane | TEOS | Si(OC₂H₅)₄ | Alfa Aesar, | Stock No: 14082, Assay: |
| | | | Ward Hill, MA | 99+% |
| Titanium (IV) isopropoxide | TIP | Ti(OiC₃H₇)₄ | Alfa Aesar | Stock No: 77115, Assay |
| | | | | 97% min. |
| Zirconium (IV) n propoxide | ZNP | Zr(OC₃H₇)₄ | Sigma Aldrich | Cat. No: 33397-2, 70 |
| | | | | wt. % solution in 1- |
| | | | | propanol |
| Poly(acrylic acid) | PAA | (C₃H₄O₂)n | Polysciences, | Cat. No: 06519-250, |
| | | | Warrington, PA | MW ~5000, 50 wt. % |
| | | | | solution in water |
| CdSe quantum dot | QC | N/A | Nanosys, Inc., | ~15 wt. % CdSe cored |
| concentrate | | | Milpitas, CA | green q-dots in |
| | | | | aminosilicone oil based |
| | | | | liquid ligands, Lot |
| | | | | #QCG052214-24, Part # |
| | | | | QCEF52035R2-01 |
| Epoxy resin | EPON 824 | N/A | Hexion, | Obtained under the trade |
| | | | Batesville, AR | designation “EPON 824 |
| | | | | EPOXY RESIN;” a |
| | | | | modified bisphenol A |
| | | | | based resin |
| Monomer | SR348 | C₂₇H₃₄O₆ | Sartomer, Exton, | Obtained under the trade |
| | | | PA | designation “SR348 |
| | | | | MONOMER;” ethoxylated |
| | | | | (2) bisphenol a |
| | | | | dimethacrylate |
| Photoinitiator | D-4265 | C₂₂H₂₁O₂PC₁₀H₁₂O₂ | BASF, Florham | Obtained under the trade |
| | | | Park, NJ | designation |
| | | | | “IGACIURE 4265;” a |
| | | | | liquid photoinitiator |
| | | | | blend of acyl phosphine |
| | | | | oxide/alpha hydroxy |
| | | | | ketone |
| 4,7,9-trioxatridecane-1,13- | TTD-diamine | C₁₀H₂₄N₂O₃ | BASF | — |
| diamine | | | | |
| Tris[2-(3- | TEMPIC | C₁₈H₂₇N₃O₉S₃ | Bruno Bock | — |
| mercaptopropionyloxy)ethyl] | | | Chemische | |
| isocyanurate | | | Fabrik, | |
| | | | Marschacht, | |
| | | | Germany | |
| Triallyl isocyanurate | TAIC | C₁₂H₁₅N₃O₃ | TCI, Portland, | — |
| | | | OR | |
| Ethyl-2,4,6- | TPO-L | C₁₈H₂₁O₃P | BASF | Obtained under the trade |
| trimethylbenzoyl | | | | designation “LUCIRIN |
| phenylphosphinate | | | | TPO-L;” a liquid UV |
| | | | | initiator |

### Preparation of Q-Dot Containing Composite Particles

Several batches of powders of the composite particles were fabricated as described below. The dried powder batches ranged in size from about 4 grams to 10 grams, and are designated as Examples 1-8 in Table 2, below. For each batch, quantum dot concentrate (QC as described in Table 1 (above)) was initially diluted with isopropanol, and an organometallic metal oxide precursor was added to the diluted quantum dot concentrate. The respective amounts of each of these components and the specific metal alkoxide used for each example are summarized in Table 2, below. Each mixture was magnetically stirred for about 1 minute at room temperature. Water only (Examples 3, 5, and 7) or polyacrylic acid-water solution (Examples 1, 2, 4, 6, and 8), in the amounts indicated in Table 2 (below), was then added to each vigorously stirring mixture. The resulting mixtures each yielded a wet paste containing the luminescent quantum dots. Each wet paste was dried with heat treatment on a hot plate in turn on aluminum foil containers at about 100° C. for about 30 minutes (120° C. for 90 minutes, for Examples using the powder designated CPZ2). The heat treatment was followed by at least 24 hours of vacuum drying. As designated, for Examples 2 and 3, the product was only dried under vacuum without prior heat treatment. After drying the paste transformed into a solid luminescent quantum dot containing material that was ground and sieved into −45 micrometer size particles. Table 2 (below) summarizes names, component amounts (in grams), and drying information for Example powders of the composite particles.

TABLE 2

| Example | Powder | QC, g | PAA, g | H₂O, g | MO Precursor*, g | IPA, g | Drying |
|---|---|---|---|---|---|---|---|
| 1 | CPZ2 | 4 | 2 | 2 | ZNP-4.8 | 4 | hot plate + vac |
| 2 | CPZ3 | 2 | 1 | 1 | ZNP-2.4 | 2 | vacuum dry only |
| 3 | CPZ4 | 2 | 0 | 1 | ZNP-2.5 | 2 | vacuum dry only |
| 4 | CPZ9 | 2 | 1 | 1 | ZNP-2.6 | 2 | hot plate + vac |
| 5 | CPZ10 | 2 | 0 | 1 | ZNP-2.7 | 2 | hot plate + vac |
| 6 | CPT2 | 2 | 1.25 | 1.25 | TIP-2 | 2 | hot plate + vac |
| 7 | CPT6 | 2 | 0 | 2 | TIP-2 | 2 | hot plate + vac |
| 8 | CPS2 | 4 | 2 | 2 | TEOS-4 | 4 | hot plate + vac |

*ZNP is 70 wt. % zirconium (IV) propoxide solution in 1-propanol

For examples CPZ3 and CPZ9 the weights of the dried samples were measured and found to be within 5% of the weight calculated by assuming 1) complete reaction of ZNP to ZrO₂, 2) negligible chemical interaction of the quantum-dot concentrate with other ingredients during complexing reaction, and 3) removal of all free IPA and water. The weight fraction of the luminescent quantum dots in these two samples was higher than 7% and the liquid quantum dot concentrate weight fraction was higher than 50%.

The analogous nominal (not measured) weight fractions in Examples CPZ4 and CPZ10 was greater than 10% and greater than 70%, for the quantum dots and for the liquid quantum dot concentrate, respectively.

### Preparation of Resins Comprising Composite Particles

Sieved sol-gel composite particles were embedded in a resin for film making. Two different types of resins were used in the Examples. The first resin (epoxy-amine chemistry) included three parts: A: epoxy resin (“EPON 824”)+15% monomer (“SR348’), B: TTD-Diamine, C: D-4265. 1 gram of the composite particles is mixed with 2.5 grams part B, 5.5 grams part A, and 0.04 gram part C. The second type resin (thiol-ene chemistry) also consists of three parts: A: TEMPIC, B: TAIC, and C: TPO-L. The three parts are premixed at 67 to 32 to 1 weight ratio respectively. 1 gram of the composite particles was mixed with 5.4 grams of the combined resin components. Comparative Example films were made from mixtures of CdSe—ZnS (core-shell) quantum dot liquid concentrate (QC) and resin components noted above.

### Film Making Using Knife Coater

Resin-composite particle mixtures were coated at a thickness of about 100 micrometers using a knife coater either between sheets of 50 micrometer thick polyethylene terephthalate (PET) film (Examples with a “P” designation and indicated to have “non-protective PET film” substrates in Table 3, below)[“P and B” are not used in Table 3], or between similar sheets of PET film having high barrier metal oxide thin film coatings (Examples with a “B” designation and indicated to have “protective barrier films” substrates in Table 3, below). Films made with the epoxy-amine resin were ultraviolet (UV) cured using a 385 nm LED light source (obtained under the trade designation “TECH CF200” from Clearstone Technologies, Inc., Hopkins, Minn.; 100-240V, 6.0-3.5 A, 50-60 Hz) for 30 seconds at 50% power, followed by heat curing in an oven for 10 minutes at 100° C. Films made with thiol-ene resin were only UV cured using a 385 nm LED light source (“TECH CF200”) for 30 seconds at 100% power. The Film examples are summarized in Table 3, below.

TABLE 3

| Example | Film | Powder | Resin | Substrate |
|---|---|---|---|---|
| 9 | CPZ2-P-TE | CPZ2 | thiol-ene | non-protective PET films |
| 10 | CPZ2-B-TE | CPZ2 | thiol-ene | protective barrier films |
| 11 | CPZ3-P-EA | CPZ3 | epoxy amine | non-protective PET films |
| 12 | CPZ3-B-EA | CPZ3 | epoxy amine | protective barrier films |
| 13 | CPZ3-P-TE | CPZ3 | thiol-ene | non-protective PET films |
| 14 | CPZ3-B-TE | CPZ3 | thiol-ene | protective barrier films |
| 15 | CPZ4-P-EA | CPZ4 | epoxy amine | non-protective PET films |
| 16 | CPZ4-B-EA | CPZ4 | epoxy amine | protective barrier films |
| 17 | CPZ4-P-TE | CPZ4 | thiol-ene | non-protective PET films |
| 18 | CPZ4-B-TE | CPZ4 | thiol-ene | protective barrier films |
| 19 | CPZ9-P-EA | CPZ9 | epoxy amine | non-protective PET films |
| 20 | CPZ9-B-EA | CPZ9 | epoxy amine | protective barrier films |
| 21 | CPZ9-P-TE | CPZ9 | thiol-ene | protective PET films |
| 22 | CPZ9-B-TE | CPZ9 | thiol-ene | protective barrier films |
| 23 | CPZ10-P-EA | CPZ10 | epoxy amine | non-protective PET films |
| 24 | CPZ10-B-EA | CPZ10 | epoxy amine | protective barrier films |
| 25 | CPZ10-P-TE | CPZ10 | thiol-ene | non-protective PET films |
| 26 | CPZ-10-B-TE | CPZ-10 | thiol-ene | protective barrier films |
| 27 | CPT2-P | CPT2 | epoxy amine | non-protective PET films |
| 28 | CPT2-B | CPT2 | epoxy amine | protective barrier films |
| 29 | CPT6-P | CPT6 | epoxy amine | non-protective PET films |
| 30 | CPS2-P | CPS2 | epoxy amine | non-protective PET films |
| 31 | CPS2-B | CPS2 | epoxy amine | protective barrier films |
| Comparative | QD-Gen1-C1-P-TE | QC only | thiol-ene | non-protective PET films |
| Example A | | | | |
| Comparative | QD-Gen1-C1-B-TE | QC only | thiol-ene | protective barrier films |
| Example B | | | | |
| Comparative | Cd-OSD-G-Ctrl-P | QC only | epoxy amine | non-protective PET films |
| Example C | | | | |
| Comparative | C-SC-NS1 | QC only | epoxy amine | protective barrier films |
| Example D | | | | |

### External Quantum Efficiency Measurement (EQE)

EQE values were measured using a standardized test procedure with a ˜3 cm² area rectangular film sample, a 440 nm excitation wavelength, and an integrating sphere apparatus (obtained under the trade designation “ABSOLUTE PL QUANTUM YIELD SPECTROMETER C11347” from Hamamatsu Corporation, Skokie, Ill.). The procedure used software obtained under the trade designation “U6039-05” from Hamamatsu Corporation.

### Ambient Lit Aging Life Test

Rectangular ˜5 cm² area samples were cut from film samples of quantum dot materials and placed in contact with the silicone lens of blue LEDs (obtained under the trade designation “LUMILEDS ROYAL BLUE LXML-PRO2” from Lumileds, San Jose, Calif.). The LEDs were well heatsinked, and operated at 20 mA providing about 25 mW of blue light with a center wavelength of 445 nm. This operating point was a small fraction of the rated current of 700 mA, at which the LEDs were expected to have lifetimes in excess of 50,000 h to 70% brightness. If the illuminated area of the film was estimated to be 16 mm², the average blue flux was roughly 160 mW/cm². The temperature of the quantum dot film was expected to be only slightly above room temperature. The LEDs were operated continuously. The emitted spectrum from each sample (and LED) was acquired periodically with a calibrated integrating sphere, fiber-coupled spectrometer (obtained under the trade designation “FOIS-1” from Ocean Optics, Dunedin, Fla.), and recorded with software written for such use. The spectra were analyzed by calculating the integrated intensity for relevant emission bands (blue: 400-500 nm, green: 500-580 nm, red: 580-700 nm). Results of ambient lit aging life test results are provided in Table 4, below.

TABLE 4

| | Hours lit with LED | |
|---|---|---|
| | (ambient temper- | |
| Film | ature - ~22° C.) | % loss in EQE |
| CPZ2-P-TE | 750 hours | 25% |
| CPZ2-B-TE | 750 hours | 1% |
| CPZ2-P-EA | 750 hours | 22% |
| CPZ2-B-EA | 750 hours | no loss |
| CPT2-P | 750 hours | 44% |
| CPT2-B | 750 hours | 50% |
| CPT6-P | 750 hours | 37% |
| CPS2-P | 750 hours | 94% |
| CPS2-B | 750 hours | no loss |
| Cd-OSD-G-Ctrl-P | 750 hours | 72% |
| C-SC-NS1 | 750 hours | no loss |
| QD-Gen1-C1-P-TE | 750 hours | 33% |
| QD-Gen1-C1-B-TE | 750 hours | no loss |

### Accelerated Aging Storage Test at 85° C.

Rectangular ˜5 cm² area samples were cut from laminated films of quantum dot materials and EQE measurements were performed on them. The samples were then placed in a constant temperature, precision oven at 85° C. After 7-9 days the samples were removed from the oven and their EQE values were measured again. The comparison of the EQE values before and after 85° C. treatment were used to evaluate degradation characteristics under accelerated aging storage conditions. The samples were not exposed to light while they were in the oven at 85° C. Results of the test are given in Table 5, below.

TABLE 5

| | | EQE before | EQE After | |
|---|---|---|---|---|
| | Days aged | 85° C. | 85° C. | |
| Film | at 85° C. | Aging | aging | % Change |
| CPZ2-P-TE | 9 | 0.877 | 0.6 | −32% |
| CPZ2-B-TE | 9 | 0.853 | 0.908 | 6% |
| CPZ3-P-EA | 8 | 0.745 | 0.073 | −90% |
| CPZ3-B-EA | 8 | 0.878 | 0.807 | −8% |
| CPZ3-P-TE | 8 | 0.867 | 0.651 | −25% |
| CPZ3-B-TE | 8 | 0.807 | 0.916 | 14% |
| CPZ4-P-EA | 8 | 0.727 | 0.061 | −92% |
| CPZ4-B-EA | 8 | 0.865 | 0.855 | −1% |
| CPZ4-P-TE | 8 | 0.909 | 0.526 | −42% |
| CPZ4-B-TE | 8 | 0.892 | 0.705 | −21% |
| CPZ9-P-EA | 8 | 0.743 | 0.069 | −91% |
| CPZ9-B-EA | 8 | 0.91 | 0.805 | −12% |
| CPZ9-P-TE | 8 | 0.87 | 0.603 | −31% |
| CPZ9-B-TE | 8 | 0.844 | 0.924 | 9% |
| CPZ10-P-EA | 8 | 0.749 | 0.099 | −87% |
| CPZ10-B-EA | 8 | 0.926 | 0.888 | −4% |
| CPZ10-P-TE | 8 | 0.967 | 0.518 | −46% |
| CPZ-10-B-TE | 8 | 0.954 | 0.817 | −14% |
| QD-Gen1-C1-P-TE | 7 | 0.633 | 0.185 | −71% |
| QD-Gen1-C1-B-TE | 7 | 0.976 | 0.841 | −14% |

### Surface Area Measurement

The surface area of a quantum-dot containing composite particle sample (CPZ-9) was measured using a surface and porosity analyzer (obtained under the trade designation “MICROMETRICS ASAP 2020 SURFACE AND POROSITY AND ANALYZER”) and software (obtained under the trade designation “MICROMETRICS ASAP 2020 VERSION 4.00” from Micromeritics Instrument Corporation, Norcross, Ga.) was used for modeling BET (Brunauer-Emmett-Teller) surface area. Surface area for the −45 micrometers sieved powder of CPZ-9 composite particles was between 3 m²/g and 4 m²/g (single point surface area=3.10 m²/g and BET surface area=3.65 m²/g).

Foreseeable modifications and alterations of this disclosure will be apparent to those skilled in the art without departing from the scope and spirit of this invention. This invention should not be restricted to the embodiments that are set forth in this application for illustrative purposes.

1. A composite particle comprising:
quantum dot light emitters;
a nonvolatile liquid ligand system; and
a hydrolyzed organometallic metal oxide precursor,
wherein the quantum dot light emitters and the nonvolatile liquid ligand system are collectively present in the composite particle in an amount of at least 30 weight percent.

2. The composite particle of claim 1, wherein the quantum dot light emitters are present in a range from 1 to 30 percent by weight of the quantum dot light emitters and the nonvolatile liquid ligand system.

3. The composite particle of claim 1, wherein the hydrolyzed organometallic metal oxide precursor is present in a range from 70 to 30 percent by weight of the composite particle.

4. The composite particle of claim 1, wherein the quantum dot light emitters comprise at least one of CdSe cores or InP cores.

5. The composite particle of claim 1, wherein the liquid ligand system comprises silicone oil.

6. The composite particle of claim 1, wherein the hydrolyzed organometallic metal oxide precursor comprises hydrolyzed metal alkoxide.

7. The composite particle of claim 6, wherein the hydrolyzed metal alkoxide is at least one of hydrolyzed zirconium n-propoxide, hydrolyzed tetraethyl orthosilicate, or hydrolyzed titanium isopropoxide.

8. A plurality of the composite particles of claim 1.

9. The plurality of the composite particles of claim 8 that is a grindable powder.

10. A film comprising the composite particles of claim 8.

11. The film of claim 10 having an External Quantum Efficiency of at least 70%.

12. An article comprising the composite particles of claim 8 in a matrix comprising thiolene.

13. A method of making composite particles of claim 8, the method comprising:
combining a mixture of quantum dot light emitters in a liquid ligand system with an organometallic metal oxide precursor;
reacting the organometallic metal oxide precursor with water; and
at least partially drying the reacted mixture to provide the composite particles.

14. A method of making composite particles, the method comprising:
combining a mixture of quantum dot light emitters in a liquid ligand system with an organometallic metal oxide precursor;
reacting the combination with a mixture of a polyacid and water; and
at least partially drying the reacted mixture to provide the composite particles,
wherein the quantum dot light emitters and all material from the liquid ligand system remaining after said reacting and said at least partially drying collectively comprises at least 30 percent by weight of the composite particles.

15. The method of claim 14, wherein the polyacid is polyacrylic acid.

16. The method of claim 14, wherein the quantum dot light emitters are present in a range from 0.5 to 20 percent by weight of composite particles.

17. The method of claim 14, wherein the amount of the organometallic metal oxide precursor reacted is in a range from 70 to 30 percent by weight of the composite particles.

18. The method of claim 14, wherein the quantum dot light emitters comprise at least one of CdSe cores or InP cores.

19. The method of claim 14, wherein the liquid ligand system comprises silicone oil.

20. The method of claim 14, wherein the organometallic metal oxide precursor is a metal alkoxide. plays.
